(19) United States
(12) Patent Application Publication
(10) Pub. No.: US 2007/0259309 A1
(43) Pub. Date: Nov. 8, 2007

(54) Dental curing device and method with real-time cure indication

(75) Inventors: John West, Arroyo Grande, CA (US); Scott Ganaja, San Luis Obispo, CA (US); Harold Hallikainen, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: DEN-MAT CORPORATION

(21) Appl. No.: 11/429,290

(22) Filed: May 8, 2006

(51) Int. Cl. A61C 1/00

(52) U.S. Cl. 433/29

(57) ABSTRACT

A light-curing unit and method for simultaneously polymerizing a light curable dental resin and determining whether the resin is optimally polymerized. A user is informed in real time when the light curable dental resin has reached optimum polymerization. The determination of optimal polymerization is made in vivo.

### BACKGROUND

Light curable composite resins have been an important part of dentistry for over 20 years. These resins are commonly used for preparing restorations, cementation of restorations, and a number of other dental restorative procedures such that light curing is now a standard procedure in dentistry.

These light curable resins used by dentists for tooth restoration and repair require a light cure unit to initiate polymerization. Initial curing lights consisted of halogen devices, first with light sources removed from the point of application and thereafter with light transmitted to the point of application through long fibers. Following that, light curing guns were introduced. These devices typically used halogen light sources with short fused fiber optic light guides close to the lamp to apply high intensity light at the point of application.

Different light cure units vary in their ability to polymerize the resin. This includes a variety of reasons including power density (mW/cm²), wavelength (nm), geometry of light as it exits the light guide and distance to the resin.

In general, the greater the power density of wavelengths matched with absorptive regions of photo-initiators used in dental resins the faster and more complete the polymerization of those resins. A decrease in power density or incompatible wavelengths can result in incomplete polymerization that can have a negative effect the quality of a dental restoration. The effects of incomplete polymerization may include patient sensitivity, an increase in secondary caries, a reduction in wear, allergic reactions, toxicity, and other restoration failures.

All light sources have the potential of degrading for a variety of electronic, electromechanical, and mechanical reasons. Light output from lamps and LED's decrease with use. Other factors contributing to a reduction of light output include miss-alignment of components in the optical path, cracks, chips, and contamination of light guides, defective control electronics, and a deterioration of filter coatings. Halogen curing lights, in particular, suffer from a wide variety of mechanisms that cause degradation of intensity. These mechanisms include loss of light output from the halogen lamp, filter degradation, buildup of resin on light guides, degradation of light guides due to sterilization and faulty voltage control circuitry.

A recent study empirically determined that degradation of light curing units is a real problem. The study accessed the light outputs of 214 quartztungsten-halogen (QTH) light polymerization units in 100 different dental offices. The study concluded that light intensity values varied significantly among the units and that the unit's age and service history substantially effected its intensity output. Many of the units exhibited intensity values well below the recommended levels. The study concluded that dentists need to regularly monitor the intensity of their light curing units and maintain the units. A failure to do so could result in providing patients with composite restorations with inferior properties. See Avedis Encioiu et al, Intensity of quartz-tungsten-halogen light-curing units used in private practice in Toronto, J. Am. Dent. Assoc., 2005 June; 136(6):766-73.

Dental radiometers were developed to measure the actual output of light from a light curing unit as a means of assessing the curing light's ability to properly polymerize the dental restorative materials.

Common radiometers in dentistry use either silicon or selenium detector cells with filters that block energy outside of the 400-500 nanometer range. Initially, radiometers were developed specifically for use with halogen light sources with their filters matched fairly closely to the wavelength distribution of the curing lights themselves. In recent years, other types of light sources have been introduced, namely plasma arc or gas pressure lamp devices, using xenon lamps to produce high intensity light in the 400-500 nanometer range. More recently, light emitting diodes (LED's) have been used to produce light specifically peaking at 470, 450 or 420 nanometers that match the absorption characteristics of photoinitiators currently used in dentistry to polymerize these restorative materials. However, when one uses a different light source on the same radiometer designed for halogen usage, erroneous readings result. Accordingly, radiometers must typically be calibrated for use relative to a given light source.

The National Institute of Standards and Technology (NIST) presently requires every radiometer to be designed specifically for the light source it's being used with. Moreover, even if one were to use a separate radiometer designed specifically for each of the three types of light sources currently used in dentistry, the problem would still remain as to how long to expose the material under a given set of conditions including depth, shade, and type of material.

Researchers in the dental field typically use a sensitive analytical laboratory tool employing a technique called Fourier Transform Infrared Spectroscopy (FTIR) to determine when a light curable material is maximally polymerized by measuring the ratio of aliphatic carbon-to-carbon double bonds pre- and post-exposure. Such laboratory equipment costs thousands of dollars and is clearly beyond the practical needs of the clinical dentist.

In Published U.S. Patent Application No. 2006/0008762, Friedman describes a radiometer that uses sensors to measure the amount of light transmitted through a test polymer wafer of a specified thickness that is held by a holder of the radiometer. The measured light is used to estimate when the test wafer is optimally cured. A user can then estimate the time for optimally curing an actual dental restoration in a patient's mouth based on the time estimated for the test sample.

This optimal sample curing time estimation is made by using a formula that relates percent conversion of the polymer to the voltage generated by sensors at any time t. The formula is derived in a lab by using FTIR spectroscopy to monitor the curing process of a standard dental resin sample of a certain thickness cured with a standard light curing unit. The FTIR produces a plot of percentage conversion versus exposure time. The same light curing unit is then used to cure an identical resin sample that is placed in the holder of the radiometer. The sample is cured and a plot of voltage generated by the sensors versus time is generated. Values for the percentage conversion and voltage generated are then selected for a certain number of time values. These selected values are used to create a plot of percentage conversion versus voltage generated and an n-polynomial fit is performed to generate the formula that is used in the estimation of the optimal cure time of a test sample cured by the user.

Thus, the Friedman radiometer suffers from many deficiencies. First, the radiometer fails to provide a user with the actual time required to optimally cure the test sample because the radiometer fails to determine when the resin is actually optimally cured. The estimation of the optimal curing time suffers from differences between the light curing unit and the type of polymer used by the dentist compared to that used to create the percentage conversion to voltage generated function. Second, the Friedman radiometer provides only an estimation of the optimal curing time of a sample in vitro but cannot be used in vivo. The optimal cure time is estimated based on the distance that the light source is held away from the test polymer wafer. But this distance may not be the same distance at which a dentist actually places the light when curing a resin of a dental restoration in a patient's mouth. Furthermore, the determination of the optimal curing time is based on the transmission of light through a dental resin while the resin is held in a test fixture. When the resin is placed in a tooth it may have different properties.

Thus, the need remains for a method and device for determining when a dental composite is actually optimally cured that is not dependant on variables such as the distance a light source is held from a test subject, the specific type of resin being cured or the light curing unit being used.

### SUMMARY OF THE INVENTION

One embodiment of the invention is a dental curing device. The device includes means for providing electromagnetic radiation to a curable substance in a patient's mouth. The device also includes means for determining when the substance is optimally cured. The device further includes means for providing a real-time positive indication to a user of when the substance is optimally cured.

Another embodiment of the invention is a dental curing device. The device includes means for emitting light. The device also includes means for transmitting the light to a light curable dental restoration. It also includes means for receiving reflected light from the dental restoration. It further includes means for measuring the amount of reflected light received in real time. The device also includes means for determining when the dental restoration is optimally cured based on the change in the amount of measured reflected light with respect to time. The device also includes means for informing the user that the restoration is optimally cured where the user is informed in real time.

Another embodiment of the invention is a self contained light curing device. The device includes a housing and one or more light emitting sources. The device also includes one or more light receiving sensors and one or more light illumination sensors. The device further includes an optical probe. The probe has light transmitting and light receiving portions. The light transmitting portion is coupled to the one or more light emitting sources and the light receiving portion is coupled to the one or more light receiving sensors. The device further includes one or more microprocessors or microcontrollers. The one or more microprocessors or microcontrollers are coupled to the output of the one or more light receiving and light illumination sensors. The device also includes one or more visual displays. The one or more displays are connected to the one or more microprocessors or microcontrollers. The device also includes one or more audio generators. The one or more audio generators are connected to the one or more microprocessors or microcontrollers. The device also includes a power supply connected to the one or more microprocessors or microcontrollers and a power supply connected to the one or more light emitting sources. The device also includes an optical feedback loop from the one or more light illumination sensors. The device further includes one or more switches connected to the one or more microprocessors or microcontrollers and one or more power supplies.

Another embodiment of the invention is a method for curing a dental polymer restoration. The method includes providing light to the restoration. The method also includes determining if the dental polymer is optimally cured. The step of providing the light and determining whether the optimal cure has been reached are performed simultaneously.

Another embodiment of the invention is a method for curing a dental polymer restoration. The method includes providing light to the restoration. The method also includes receiving light from the restoration. The amount of light received is measured in real time. The degree of polymerization of the restoration is estimated in real time. The method also includes displaying the estimated degree of polymerization to a user in real time.

Another embodiment of the invention is a method for polymerizing a light curable resin in a dental restoration. The method includes placing an optical probe in proximity to a resin in a dental restoration. The resin of the dental restoration is illuminated with light emitted from one or more light emitting sources. Reflected light from the light curable resin of the dental restoration is received. The received reflected light is measured with the one or more light receiving sensors. The light from the light emitting sources is measured with one or more light illumination sensors. The output of the one or more light emitting sources is stabilized by adjusting the output of the light emitting sources with an optical feedback loop that regulates voltage and/or current to the light emitting sources from the power supply. Whether or not the resin is fully polymerized is determined by analyzing the change in the amount of reflected light received from the resin in the dental restoration as the resin polymerizes. A user is visually informed when the resin is determined to be fully polymerized. An audio signal is created when the resin is determined to be fully polymerized. The one or more light emitting sources are deactivated when the resin is determined to be fully polymerized.

Another embodiment of the invention is a dental light guide. The dental light guide includes means for transmitting light to a resin of a dental restoration inside a patient's mouth. The light guide also includes means for receiving light that is reflected back from the dental restoration and transmitting this light to one or more light sensing devices.

### BRIEF DESCRIPTION OF THE DRAWINGS

FIG. 1 shows a plot of the spectral irradiance of light transmitted through a first dental resin. Irradiance was measured at the back of the resin sample and transmission was plotted as total exposure time increased.

FIG. 2 shows a plot of the spectral irradiance of light transmitted through a second dental resin. Irradiance was measured at the back of the resin sample and transmission was plotted as total exposure time increased.

FIG. 3 shows a plot of the spectral irradiance of light reflected from a first dental resin. Irradiance was measured at the front of the resin and reflectance was plotted as exposure time increased.

FIG. 4 shows a plot of the spectral irradiance of light reflected from a second dental resin. Irradiance was measured at the front of the resin and reflectance was plotted as exposure time increased.

FIG. 5 shows a plot of sensor output. The sensor output is proportional to the amount of reflected light received from a dental resin. Sensor output was plotted as exposure time increased.

FIG. 6 shows a plot of sensor output and resin hardness. The sensor output is proportional to the amount of reflected light received from a dental resin. Sensor output and resin hardness were plotted as exposure time increased.

FIG. 7 shows a plot of relative light intensity from a number of different light curing units as the distance from the tip of the light guide increased from 0 mm to 10 mm.

FIG. 8 shows the external elements of a light curing unit of one embodiment of the present invention.

FIG. 9 shows a cross-sectional view of an optical probe of a light curing unit of one embodiment of the present invention.

FIG. 10 depicts a perspective view of an optical probe of a light curing unit of one embodiment of the present invention.

FIG. 11 shows a clear disposable sleeve that can cover the optical probe for infection control.

FIG. 12 shows different configurations of transmitting and receiving fibers that can be used in the optical probe of one embodiment of the present invention.

FIG. 13 shows transmitting and receiving fibers in a hemispherical pattern that can be used in the optical probe of one embodiment of the present invention.

FIG. 14 depicts a light curing unit with a non-fiberoptic optical probe with optically isolated light transmitting and light receiving means of one embodiment of the present invention.

FIG. 15 shows the distal end of an optical probe with optically isolated light transmitting and light receiving means of one embodiment of the present invention.

FIG. 16 shows a cross-sectional view of the inner workings of a light curing unit of one embodiment of the present invention.

FIG. 17 shows a block diagram of the electronic elements of a light curing unit of one embodiment of the present invention.

FIG. 18 shows an optical probe of a light curing unit of one embodiment of the present invention in operation in close proximity to a tooth containing a dental resin to be cured.

### DESCRIPTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other devices and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein. Further, although certain embodiments are shown in the figures, the present invention is certainly not intended to be limited to these portrayed embodiments.

The present inventors have recognized the need for a method and device that provides real time indication of when a dental resin is optimally cured while the dental resin is in a patient's mouth. Thus, the present invention provides a light curing device and method for indicating when a dental resin is optimally cured that is not dependant on extraneous factors such as the light curing unit being used, the dental resin being used, or the distance away from a test resin composite the light curing unit is placed.

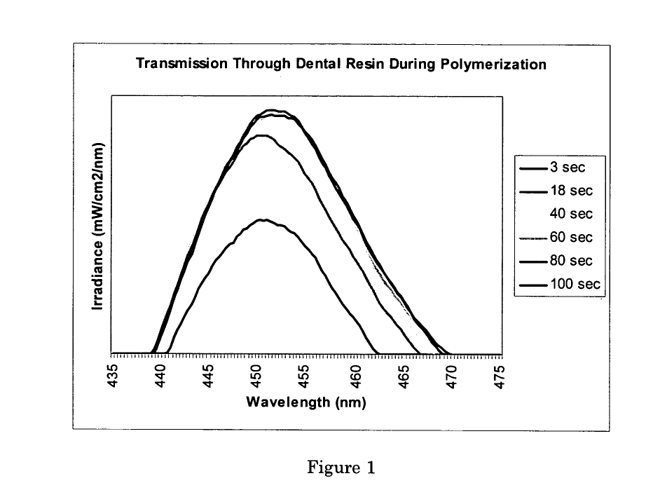

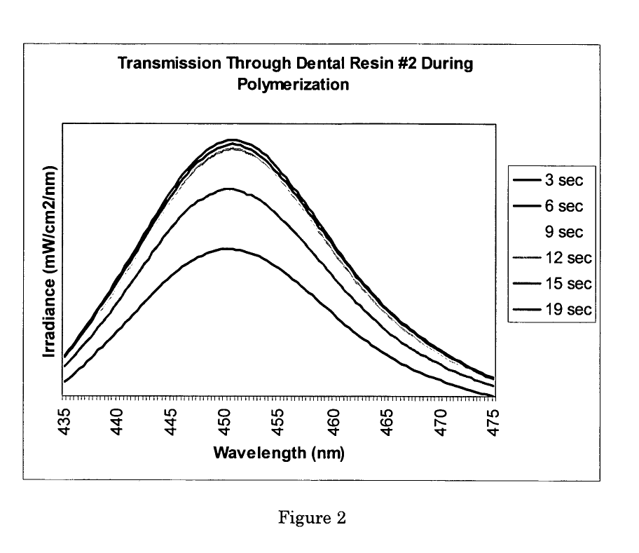

The present inventors have also found that as the degree of polymerization of a resin increases the percentage of light transmitted through the resin increases until a maximum level of transmission is reached at the point where the resin is fully cured. Additionally, the present inventors have found that the resin hardness values correspond with the exposure time so that the resin reaches maximum hardness values at the same time that light transmission peaks. Thus, any additional exposure of the resin to light does not effect the percentage of light transmitted through the resin. Accordingly, the time at which the resin is optimally cured can be determined based on the point at which the percentage of transmitted light is determined to not increase with additional exposure. FIG. 1 illustrates this property for a first dental resin, Jeneric/Pentron Inc. Sculpt-It Shade A3. As the plot clearly shows, additional exposure beyond 60 seconds does not effect the intensity of the light measured that is transmitted through the resin. Moreover, the transmission of light at 18 seconds is about 80% of the maximum transmission. FIG. 2 clearly shows that this property holds for a second resin, Dentsply Caulk TPH Spectrum Shade A3. For the second resin, exposure beyond 12 seconds has very little effect on the amount of light transmitted through the resin. Moreover, the transmission of light at 9 seconds is about 80% of the maximum transmission.

The present inventors have also found that the in vivo optimal cure time of a dental resin can be determined by measuring the amount of light reflected from the dental resin. As the degree of polymerization increases, the amount of light reflected from the resin decreases. Once the maximum polymerization is achieved, the amount of light reflected reaches a minimum and holds steady. Therefore, by measuring the amount of light reflected from a dental resin, the time at which the minimum is reached can be determined which corresponds to the optimal curing time. Thus, the optimal curing time can be determined for any dental restoration or other implement while the restoration or implement is in the patient's mouth. Thus, the present invention can provide a dentist with real-time indication of when an actual patient's dental resin restoration is optimally cured while the restoration is in the patient's mouth. This principle also can be applied to indirect restorations outside of the patients mouth.

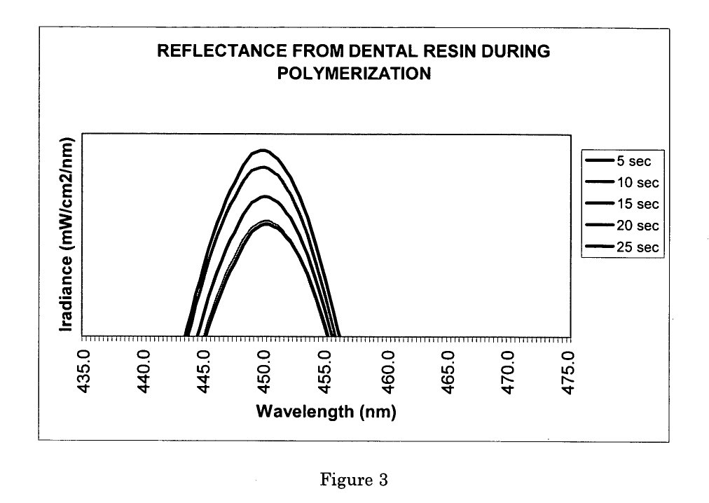

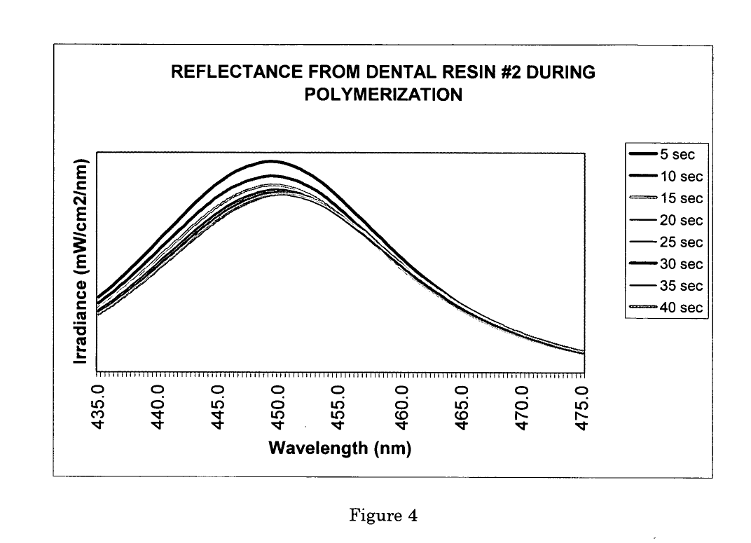

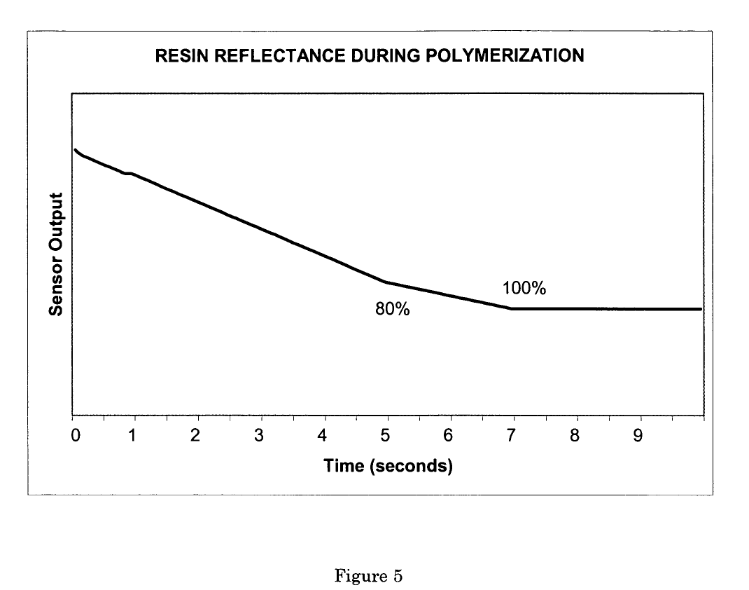

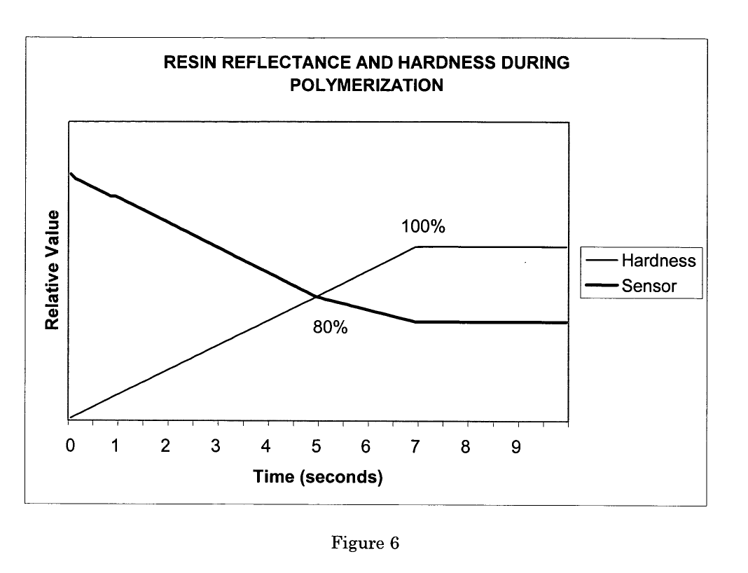

The property of the reflectance minimum is illustrated in FIGS. 3 and 4. FIG. 3 clearly shows that subsequent exposures beyond 20 seconds of a first resin, Jeneric/Pentron Inc. Sculpt-It Shade A3, to light do not change the amount of light reflected by the resin. After 15 seconds the reflected light of FIG. 3 is about 80% of the minimum intensity. FIG. 4 shows this property holds for a second resin, Parkell Epic-AP Shade A2. For the resin used in FIG. 4 it can be clearly seen that additional exposures beyond 20 seconds have very little effect on the amount of light reflected by the resin. After 15 seconds the light of FIG. 4 is about 90% of the minimum intensity. Similarly, FIG. 5 shows the change of light sensor output with curing time. Light sensor output is proportional to the amount of reflected light received from the dental resin being cured. FIG. 5 clearly shows that the sensor output remains constant after about 7 seconds of curing time. The figure also shows that the sensor output is 80% of the way to the minimum output at about 5 seconds of curing time. FIG. 6 shows that resin hardness corresponds to sensor output. Thus, after about 7 seconds of cure time, the resin has reached its maximum hardness, is fully cured, and will continue to reflect the same amount of light. The figure also shows that at about 5 seconds of curing time the resin has reached about 80% of maximum hardness which corresponds to the sensor output being 80% of the way to the minimum sensor output.

The present inventors have also recognized the importance of the distance the light curing unit is held from the dental resin restoration. Radiometers commonly used measure the light output at the face of the light guide at a distance representative of 0 mm. However, this is not how light cure units are used. In practice, the cusp of the tooth in the patient's mouth prevents the light guide from being placed in direct proximity to the restoration. Further, the floor of a deep cavity preparation may be 4 mm or more from the surface of the tooth. In addition, because of the location of the restoration it is often impossible for the dentist to position the light guide directly on the resin.

As described above, the radiometer of U.S. 2006/0008762 can measure the light transmission through a test dental resin wafer but this distance is not necessarily the distance the light curing unit is held away from the dental resin in actual practice.

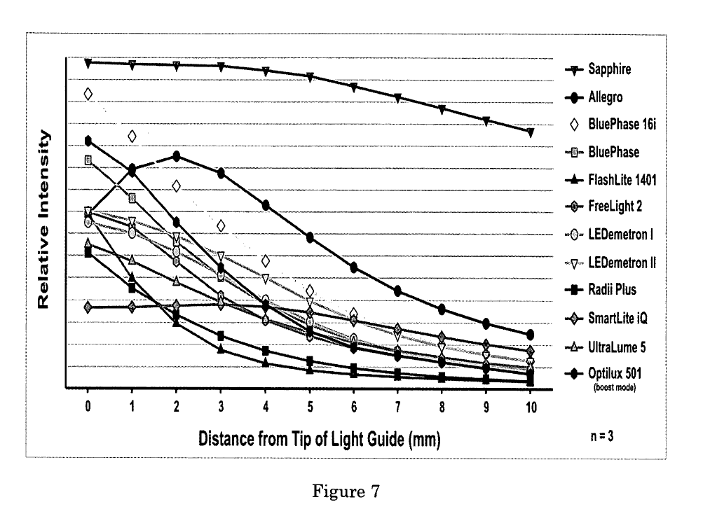

FIG. 7 shows the effect of distance on the power density of several commercial light curing units. As the figure clearly demonstrates, the intensity substantially decreases with distance. Moreover, because it is well known that optimal cure time is largely dependant on the intensity of light the resin is exposed to, the distance at which the light curing unit is held away from the dental resin restoration is plainly an important variable in determining when the restoration is optimally cured.

One embodiment of the present invention is a method for curing a dental resin composite. The method includes providing a certain type of electromagnetic radiation to a dental resin in a patient's mouth. The amount of light reflected by the dental resin is measured as the light is applied. This measurement is used to determine when the dental resin is optimally cured. The user is alerted at the time the optimal cure is reached.

The source of the electromagnetic radiation can be any commonly used in the dental curing arts. Common sources include halogen, xenon, LED, LED emitters, LED dies, metal halide, mercury vapor, sodium and laser light sources. Of course, any other light source could be used with the present invention. The radiation may also be provided through a dental light guide such as a fiber optic guide as is well known in the art.

The amount of light reflected from the dental resin can be measured by any known method. For example, any type of solid state sensing device can be used or any other device that is well known in the art. Common solid state sensing devices include photodiodes, photo-detectors, phototransistors, light to analog light sensors, light to digital light sensors and light to frequency light sensors. The solid state sensing device preferably generates a signal that is proportional to the amount of reflected light received from the dental resin.

The measured reflected light can be used to determine the optimal cure time by comparing a function related to the amount of light reflected (or the sensor output) at any time t+tᵢ to the same function at any time t, where tᵢ represents some time interval. At the time t+tᵢ where the function is determined to be substantially the same as the function at time t, the optimal cure time has been reached. The function may be any function of the measured reflected light. Exemplary functions include the measured reflected light and the rate of change of the reflected light.

For example, the rate of change of reflected light could be determined for any time t₂ by equation 1,

$${r}_{2} = \frac{{m}_{2} - {m}_{1}}{{t}_{2} - {t}_{1}} \qquad ( 1 )$$

where r₂ is the rate of change of reflected light at time t₂, m₂ is the measured reflected light at time t₂ and m₁ is the measured reflected light at some earlier time t₁. The calculated rate of change of reflected light at t₁ could be determined by equation 2,

$${r}_{1} = \frac{{m}_{1} - {m}_{0}}{{t}_{1} - {t}_{0}} \qquad ( 2 )$$

where r₁ is the rate of change of reflected light at t₁, m₁ is as before, and m₀ is the measured reflected light at some time t₀ previous to t₁. The rate of change at t₂ could then be compared to the rate of change at t₁. When the value of r₁-r₂ is zero or approaches zero, the restoration is optimally cured or approaching full cure. This is illustrated by Equation 3.

$${lim}_{( {r}_{2} - {r}_{1} ) \to 0} ( \% Cure ) \to 100 \qquad ( 3 )$$

Of course, this algorithm could use any value that is close to zero to determine that the restoration is sufficiently optimally cured. Any other method that is commonly used in determining when a minimum has been reached with respect to time of any measured variable could be used as is well known in the art of measuring instrumentation.

The present invention may also include a method of estimating the percentage conversion of a polymer restoration being cured. The estimation could be based on a formula that relates percentage conversion to the amount of reflected light measured or the sensor output.

The user can be alerted when the dental resin is optimally cured by any known method. The alert could be visual, audio, tactile any combination. For example, a message could be displayed that alerts the user that the optimal cure time has been reached. An alarm could also sound when the optimal cure time has been reached. A vibration could also be initiated when the optimal cure time is reached.

Another embodiment of the present invention is a dental curing device that provides real time indication of when a dental resin restoration is optimally cured. The device includes a housing. The device further includes means for emitting and transmitting light to a dental resin inside a patient's mouth. The device further includes means for receiving light reflected from the dental resin and means for measuring the amount of light reflected from the dental resin. The device further includes means for determining when the dental resin is optimally cured based on the measured reflected light. The device further includes means for alerting a user that the optimal cure time has been reached.

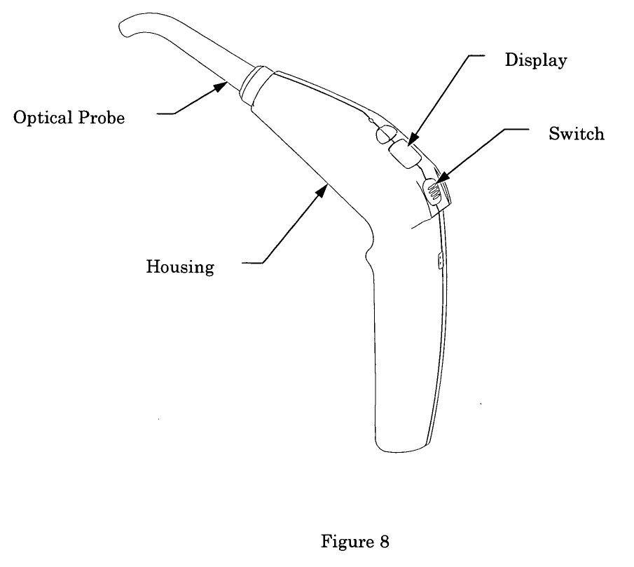

FIG. 8 shows one embodiment of the present invention. The figure displays an exterior of a light curing unit with an optical probe. The exterior of the light curing unit also includes a housing, a display, and switches.

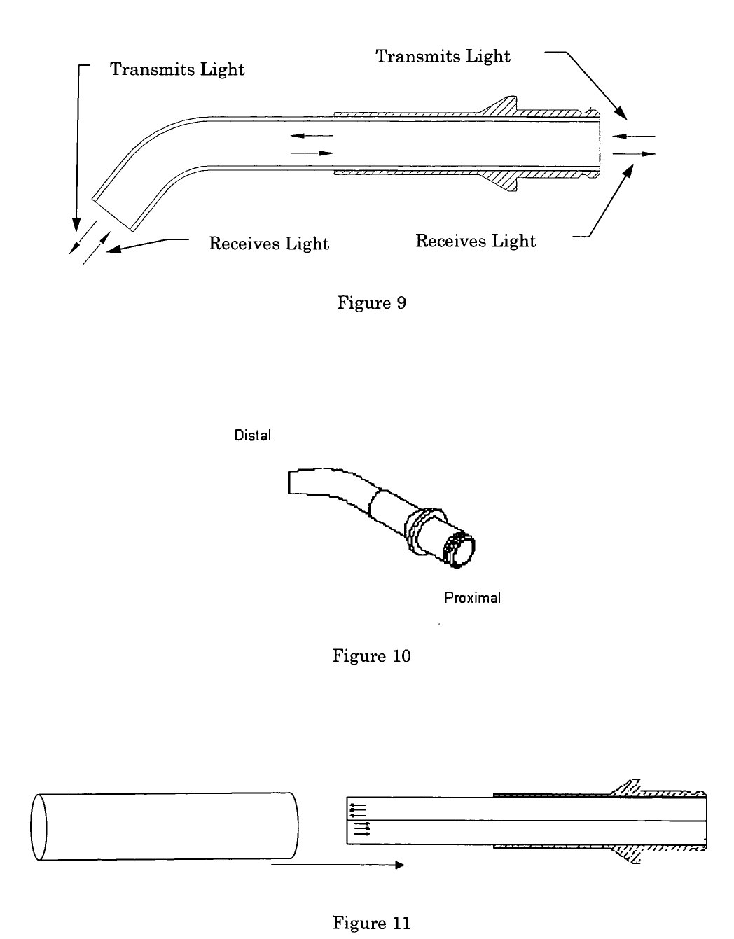

FIG. 9 shows a cross sectional view of the optical probe of the light curing unit. FIG. 10 shows a perspective view of the optical probe. FIG. 11 shows a disposable sleeve that can cover the optical probe and disposed after each use in order to prevent infection. The optical probe both has both transmitting means to transmit light to an object to be cured and receiving means to receive light reflected from the object. The optical probe may be fiber optic, glass or plastic. In the preferred embodiment, the optical probe is a light guide made by fusing together many individual fibers and commonly known as image conduit.

Single fibers can be fused together to form what are called multifibers. Multifibers have essentially the same mechanical properties as single fibers of equivalent dimension; their diameters determine whether they are flexible or rigid. Multifibers are coherent bundles; that is, the relative position of each filament is the same at the input end as at the output end. Filament length and relative position between input and output are unimportant because the light they conduct is trapped within the fiber.

Multifibers, in turn, can be fused together to form image conduit, an actual image carrier. Resolution is limited by the size and packing density of the individual fibers as well as by, the care exercised in packing the multifibers. Image conduit has little or no flexibility but can be bent with heat to conform to almost any desired path. Image conduit can be made with small fiber elements for high resolution. It is inexpensive, rugged, and relatively free from distortion.

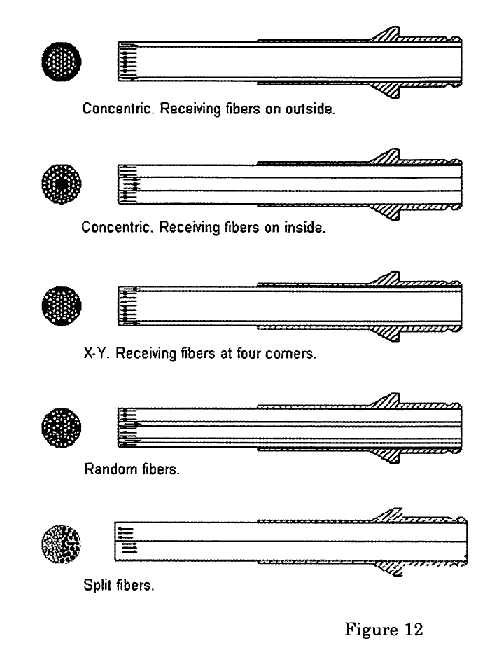

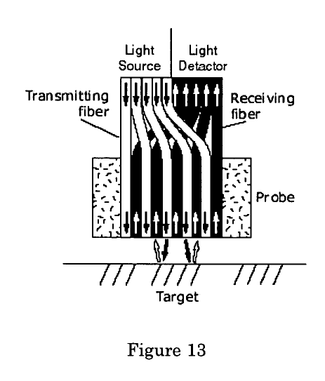

FIG. 12 shows different configurations of transmitting and receiving fibers that can be used in the optical probe of the present invention. FIG. 13 depicts different fibers transmitting light to a target and receiving light from a target. The fibers are arranged in a hemispherical pattern. In a preferred embodiment, the fibers are concentrically arranged such that transmitting are on the inside of the probe and receiving fibers are on the outside of the probe surrounding the transmitting fibers.

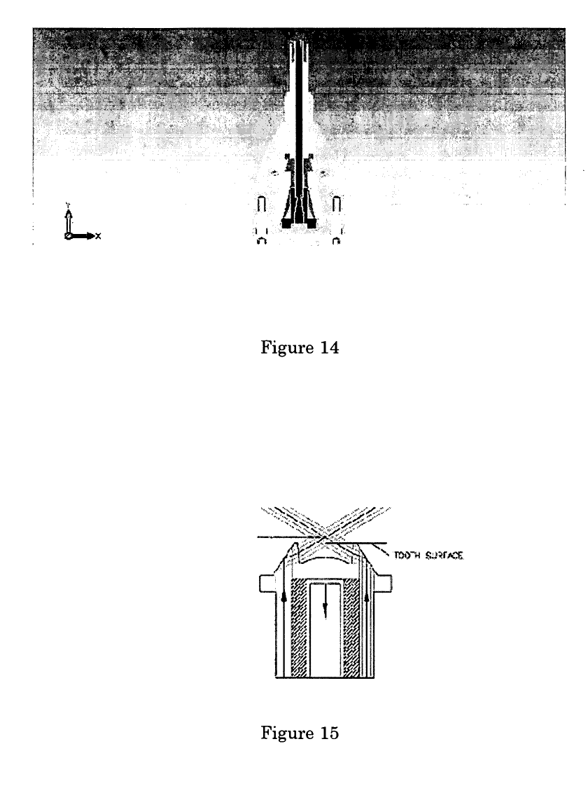

FIG. 14 shows an optical probe of an alternative embodiment of the present invention. In this embodiment, a single rod or tube is used as the light transmitting means and a single rod or tub is used as the light receiving means, each optically isolated from the other. In this embodiment, the optical probe is a non-fiberoptic probe. For example a solid glass rod such as a clad rod, a plastic rod, or a tube could be used. In addition, a lens may be included in the assembly. In the embodiment depicted by FIG. 14, light transmitting occurs in the outer optical path and light receiving occurs in the center. However, light transmitting and light receiving may occur in either the center or outer optical paths. A lens on the distal end of the probe is used to focus transmitted light to the target so that reflected light from the target is received into the light receiving optical path. Further, the lens is used to eliminate specular reflection or glare from the reflected light received. In this embodiment the optical probe may contain a total internal reflection (TIR) element as described in co-assigned issued U.S. Pat. No. 6,733,290, Published U.S. Application No. US 2004-0141336 and U.S. patent application Ser. No. 11/016,750, each of which is hereby incorporated by reference in its entirety.

FIG. 15 shows a view of the distal end of the embodiment of the optical probe shown in FIG. 14. The figure shows the distal end of the optical probe transmitting light to a tooth and receiving reflected light from the tooth. As the figure shows, the lens is arranged such that the focal point of the light is slightly away from the distal end of the probe so that more light shines on the tooth surface if the device is not exactly on the tooth surface or is slightly tipped. This extra illumination helps to offset the natural loss of light as the light source or sensor are moved away from the tooth surface. The figure also shows divergent cones of light shining on the tooth surface. These cones appear as rings when illuminating the approximately flat surface of a tooth.

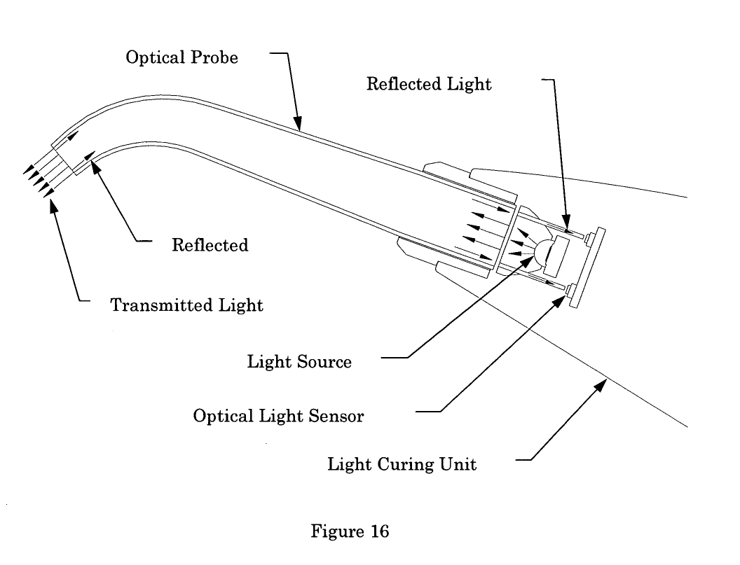

FIG. 16 shows inner workings of the light curing unit. The optical probe is coupled to a light source and light sensors. The light source transmits light to the optical probe which carries the light through the probe to the object to be cured. The optical probe then receives reflected light from the object to be cured and transmits it through the probe to the optical light sensors.

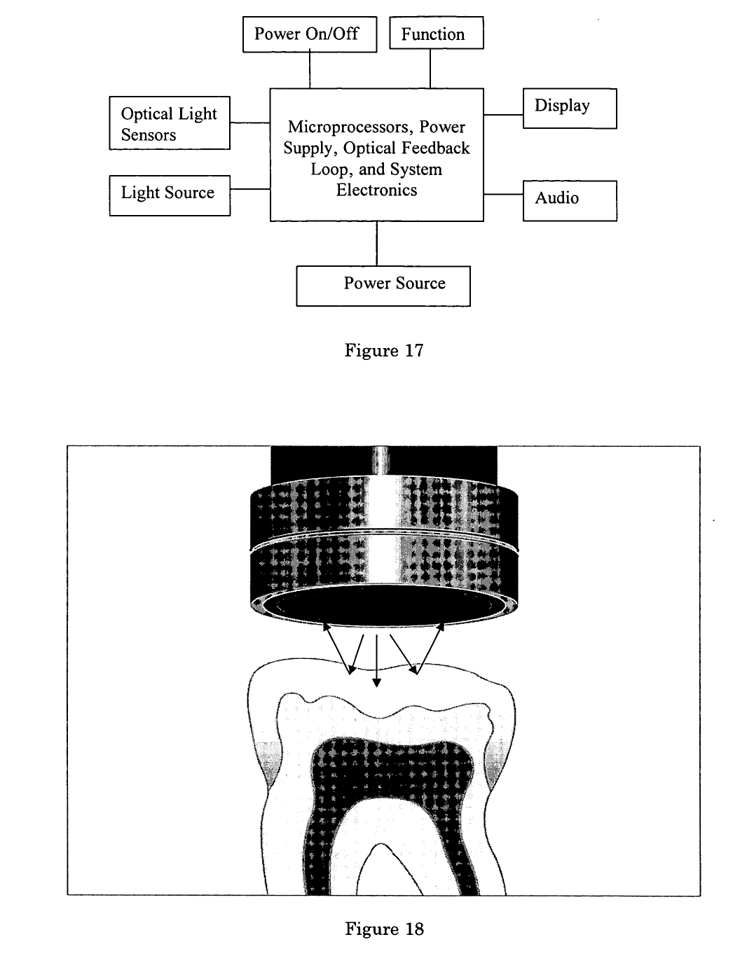

FIG. 17 shows a block diagram of the electronic elements of the light curing unit of one embodiment of the present invention. In operation, the user would first turn the unit on by pressing the power button. The user would then choose the desired function. The functions include Cure Indication On, Cure Indication %, and Calibrate. Under the Cure Indication On function, when activated the light emitters stay on until the cure indication senses that optimal cure has been reached. An algorithm (as described above) will determine when to signal when curing is complete and turn the light off.

Under Cure Indication %; some value, e.g. 80%, is preprogrammed or adjusted by the operator. When the preprogrammed amount is estimated to have been reached, the light would signal and turn off. This estimation could be based on a formula that estimates percent conversion based on amount of reflected light measured or sensor output.

The formula could be calculated in a similar manner to the formula used in Published U.S. Patent Application No. 2006/0008762, which is hereby incorporated by reference in its entirety. A test resin sample or an actual dental restoration could be cured with the light curing unit of the present invention. The curing process could be monitored using FTIR spectroscopy to generate a plot of percent polymer conversion versus curing time. During the same curing process or a separate curing process using an identical resin sample or restoration, the light curing unit of the present invention could be used to generate a plot of amount of light reflected or sensor output versus curing time. Values from each of the measured percent conversion and sensor output could be then be selected for a series of time values. These selected values could then be plotted to generate a percentage conversion versus sensor output. An n-order polynomial fit could then be calculated to generate a function that provides percentage conversion for any sensor output. Of course any other method could be used to determine such a function from the percentage conversion and sensor output measurements.

Under the Calibrate function; the user could use a sample of polymer of identical shape and thickness as the sample used to generate the percentage conversion-sensor output function. The light curing unit could be used to cure the sample and the determined optimal curing time could be compared to the estimated optimal curing time from the conversion-sensor output function. The conversion/sensor output function could then be adjusted based on this difference.

Under any of the functions, the estimated percentage conversion could be displayed if desired.

Once the user selected a function, the user could then select the desired Cure Mode or Light Output Profile. The modes include: Full Power, User Adjustable Power, Pulse Frequency Mode, Pulse Delay Mode, and Ramp Mode. These different modes would provide users that believe that slower curing causes less resin shrinkage and stress different options.

If the user wanted to use the light to cure a dental restoration, the user would select the desired function and mode. The user would then place the optical probe of the light curing unit in proximity to the dental restoration in a patient's mouth. The user would then press the activator button to cause light to be emitted from the light source through the optical probe to the dental restoration. Light reflected from the restoration would then be received by the optical probe. FIG. 18 shows a close-up of light being simultaneously transmitted and received by the optical probe.

The reflected light would then be transmitted through the probe to the one or more light receiving sensors. The sensors would then generate a signal and transmit the signal to the microprocessor or microcontroller. The microprocessor or microcontroller would receive the signal and using an algorithm determine if the optimal curing time had been reached. At the time the optimal curing time is reached, the microprocessor or microcontroller would communicate with the display and the audio element. The microprocessor would cause the display to show a message such as “Cure Complete”, cause the audio element to sound an alarm such as a “beep”, start the vibration generator, and shut off the light emitting source.

The means for emitting light can be any commonly used light source in the dental curing arts such as halogen, xenon, LED, LED emitters, LED dies, LED arrays, metal halide, mercury vapor, sodium and laser light sources. Of course, any other light source could be used with the present invention. The means for measuring the amount of light reflected from the dental resin can include any known devices for measuring reflected light in the optics arts. For example, any type of solid state sensing device can be used or any other device that is well known in the art. Common solid state sensing devices include photodiodes, photo-detectors, phototransistors, light to analog light sensors, light to digital light sensors and light to frequency light sensors. In a preferred embodiment, the solid state sensing device generates a signal that is proportional to the amount of reflected light received from the dental resin.

The means for determining the optimal curing time from the amount of light reflected can include any computation device such as at least one microprocessor or microcontroller. The microprocessor or microcontroller could use the algorithm described above for determining when the actual optimal curing point has been reached. Of course the microprocessor or microcontroller could use any other algorithm that is commonly used in determining when a minimum has been reached with respect to time of any measured variable as is well known in the art of measuring instrumentation. Moreover, any other device could be used as is well known in the art of measuring instrumentation.

The means for alerting the user when the dental resin is optimally cured could include any common component or device used for signaling or alerting. The alert could be visual, audio, tactile or any combination thereof. For example, the dental curing device could include a display that alerts the user that the optimal cure time has been reached. The display could be any type of display such as LCD or a light. The alert displayed could be any alert such as a blinking light or a textual message such as “Curing Complete.” The device could also include an alarm that emits a sound when the optimal cure time has been reached. The device could also include means for generating a vibration when the optimal cure time is reached. Any means for generating the vibration could be used such as the technology that is used in vibrating cellular telephones or any other technology as is well known in the signaling arts.

The device may also include one or more light illumination sensors that measure the amount of light emitted by the one or more light sources. The one or more light illumination sensors are coupled to the at least one microprocessor or microcontroller. The at least one microprocessor or microcontroller can stabilize the output from the light sources by adjusting the output with an optical feedback loop.

The device also optionally includes means for transmitting data from the device to an external medium such as a computer. For example, the device could transmit the amount of light reflected from the dental resin to an external microprocessor or microcontroller which could create a visual plot displayed on an external monitor or other display device of the change in the amount of reflected light with respect to time. A plot of the estimation of the percentage of polymerization could also be generated.

Although certain embodiments of the invention have been described, the invention is not meant to be limited in any way to just these embodiments. The embodiments described herein are exemplary only. The invention is only limited by the appended claims.

1. A dental curing device comprising:
means for providing electromagnetic radiation to a curable substance in a patient's mouth;
means for determining when the substance is optimally cured; and
means for providing real-time positive indication to a user of when the substance is optimally cured.

2. The curing device of claim 1 wherein the means for providing electromagnetic radiation comprises one or more light source and an optical probe.

3. The curing device of claim 2 wherein the one or more light source is selected from the group consisting of halogen, xenon, and LED, LED emitters, LED dies, LED Arrays, metal halide, mercury vapor, sodium and laser light sources.

4. The curing device of claim 2 wherein the optical probe is selected from the group consisting of fiber optic, glass, and plastic optical probes.

5. The curing device of claim 1 wherein the means for determining when the substance is optimally cured comprises at least one solid state light sensing device and at least one microprocessor or microcontroller.

6. The curing device of claim 5 wherein the at least one solid state light sensing device generates a signal that is proportional to the amount of reflected light received from the curable substance.

7. The curing device of claim 6 wherein the at least one microprocessor or microcontroller receives the signal generated by the at least one solid state sensing device and compares the value of a signal to a previously received signal from the sensor in order to determine if the curable substance is optimally cured.

8. The curing device of claim 5 wherein the at lest one solid state light sensing device is selected from the group consisting of photodiodes, photo-detectors, phototransistors, photoresistors, light to analog light sensors, light to digital light sensors and light to frequency light sensors.

9. The curing device of claim 1 wherein the means for providing a real-time positive indication is selected from the group consisting of visual displays, audio generators, vibration generators, and any combination thereof.

10. The curing device of claim 2 wherein the optical probe comprises a disposable element for infection control.

11. A dental curing device comprising:
means for emitting light;
means for transmitting the emitted light to a light curable dental restoration;
means for receiving reflected light from the dental restoration;
means for measuring the amount of reflected light received in real time;
means for determining when the dental restoration is optimally cured based on the change in the amount of measured reflected light with respect to time; and
means for informing the user in real time that the restoration is optimally cured.

12. The curing device of claim 11 wherein the means for emitting light is selected from the group consisting of halogen, xenon, and LED light sources.

13. The curing device of claim 11 wherein the means for transmitting the light is selected from the group consisting of fiber optic, glass, and plastic optical probes.

14. The curing device of claim 11 wherein the means for receiving the reflected light is selected from the group consisting of fiber optic, glass, and plastic optical probes.

15. The curing device of claim 11 wherein the means for transmitting the light and the means for receiving the reflected light comprise a single optical probe.

16. The curing device of claim 15 wherein the optical probe comprises optical fibers.

17. The curing device of claim 16 wherein the optical fibers are arranged in a configuration selected from the group consisting of: concentric with the receiving fibers surrounding the transmitting fibers, concentric with the transmitting fibers surrounding the receiving fibers, hemispherical with transmitting fibers on one half of the optical probe cross section and receiving fibers on the other half, and random with transmitting and receiving fibers randomly dispersed throughout the cross section of the optical probe.

18. The curing device of claim 17 wherein the optical fibers are arranged in the concentric with the receiving fibers surrounding the transmitting fibers configuration.

19. The curing device of claim 15 wherein the optical probe comprises a disposable element for infection control.

20. The curing device of claim 11 wherein the means for measuring the amount of reflected light received is selected from the group consisting of photodiodes, photo-detectors, phototransistors, photoresistors, light to analog light sensors, light to digital light sensors and light to frequency light sensors.

21. The curing device of claim 20 wherein the means for measuring the amount of reflected light received generates a signal that is proportional to the amount of reflected light received.

22. The curing device of claim 21 wherein the means for determining when the dental restoration is optimally cured comprises at least one microprocessor or microcontroller.

23. The curing device of claim 22 wherein the at least one microprocessor or microcontroller receives the signal generated by the at least one sensor and compares a mathematical function of the value of the received signal to the same mathematical function of a value of a previously received signal from the sensor in order to determine if the dental restoration is optimally cured.

24. The curing device of claim 23 wherein the mathematical function is the rate of change in the value of the received signal.

25. The curing device of claim 11 wherein the means for informing the user is selected from the group consisting of visual displays, audio generators, vibration generators, and any combination thereof.

26. A self contained light curing device comprising:
a housing;
one or more light transmitting sources;
one or more optical light receiving optical sensors;
one or more optical light illumination optical sensors;
an optical probe comprising light transmitting and light receiving portions wherein said light transmitting portion is coupled to the one or more light transmitting sources and said light receiving portion is coupled to the one or more optical light receiving sensors;
one or more microprocessors or microcontrollers coupled to the output of the one or more optical light receiving and light illumination sensors;
one or more visual displays connected to the one or more microprocessors;
one or more audio generators connected to the one or more microprocessors;
a power supply connected to the one or more microprocessors;
a power supply connected to the one or more light transmitting sources;
an optical feedback loop from the one or more optical light illumination optical sensors; and
one or more switches connected to the one or more microprocessors and one or more power supplies.

27. The curing device of claim 26 wherein the optical probe comprises:
a light transmitting portion; and
a light receiving portion,
wherein the light transmitting portion comprises a proximal end coupled to the one or more light transmitting sources and a distal end for projecting light onto a dental resin restoration, wherein the light receiving portion comprises a distal end for receiving light from the dental restoration and a proximal end coupled to the one or more optical light receiving sensors, and wherein the light transmitting and light receiving portions are optically isolated from each other.

28. The curing device of claim 26 wherein the optical probe comprises a disposable element for infection control.

29. A method for curing a dental polymer restoration, the method comprising:
providing light to the restoration; and
determining if the restoration is optimally cured,
wherein the step of providing and determining are performed simultaneously.

30. The method of claim 29 wherein the step of providing light to the restoration comprises:
providing light to an optical probe; and
transmitting the light through the optical probe to the dental restoration.

31. The method of claim 29 wherein the step of determining if the restoration is optimally cured comprises:
receiving light reflected from the dental restoration;
generating a signal proportional to the amount of reflected light received; and
comparing a mathematical function of the signal generated at a later time with the same mathematical function of a signal generated at an earlier time.

32. The method of claim 31 wherein the mathematical function is the rate of change in the value of the signal generated.

33. A method for curing a dental polymer restoration, the method comprising:
providing light to the restoration;
receiving light from the restoration;
measuring the amount of light received in real time;
estimating the degree of polymerization of the restoration in real time; and
displaying the estimated degree of polymerization to a user in real time.

34. The method of claim 33 wherein the step of providing light to the restoration comprises:
providing light to an optical probe; and
transmitting the light through the optical probe to the dental restoration.

35. The method of claim 33 wherein the step of measuring the amount of received light comprises generating a signal proportional to the amount of reflected light received.

36. The method of claim 35 wherein the step of estimating the degree of polymerization comprises plugging the value of the signal generated into an empirical mathematical equation relating percentage polymerization to signal generated.

37. A method for polymerizing a light curable resin in a dental restoration, the method comprising the steps of:
placing an optical probe in proximity to a resin in a dental restoration;
illuminating the resin of the dental restoration with light emitted from one or more light transmitting sources;
measuring reflected light received from the resin of the dental restoration with one or more optical light receiving sensors;
measuring the light from the light transmitting sources with one or more optical light illumination sensors;
stabilizing the output of the one or more light transmitting sources by adjusting the output of the light transmitting sources with an optical feedback loop;
determining if the resin of the dental restoration is fully polymerized by analyzing the change in the measured amount of reflected light received from the resin in the dental restoration as the resin polymerizes;
visually informing a user when the resin is determined to be fully polymerized;
creating an audio signal when the resin is determined to be fully polymerized; and
deactivating the one or more light transmitting sources when the resin is determined to be fully polymerized.

38. A dental light guide comprising:
means for transmitting light received from one or more light sources to a resin of a dental restoration inside a patient's mouth; and
means for receiving light reflected from the dental restoration and transmitting the received reflected light to one or more light sensing devices.

39. The dental light guide of claim 38 wherein the means for transmitting light received from one or more light sources comprise transmitting optical fibers and wherein the means for receiving light reflected from the dental restoration comprise receiving optical fibers and wherein the transmitting optical fibers and the receiving optical fibers are mutually distinct and wherein the transmitting optical fibers and the receiving optical fibers are contained in a single optical probe.

40. The dental light guide claim of 39 wherein the transmitting and receiving optical fibers are arranged in a configuration selected from the group consisting of: concentric with the receiving fibers surrounding the transmitting fibers, concentric with the transmitting fibers surrounding the receiving fibers, hemispherical with transmitting fibers on one half of the optical probe cross section and receiving fibers on the other half, and random with transmitting and receiving fibers randomly dispersed throughout the cross section of the optical probe.

41. The dental light guide of claim 40 wherein the transmitting and receiving optical fibers are arranged in the concentric with the receiving fibers surrounding the transmitting fibers configuration.

42. The dental light guide of claim 39 wherein the means for transmitting light received from one or more light sources comprise a first single rod or tube and wherein the means for receiving light reflected from the dental restoration comprise a second single rod or tube and wherein the first single rod or tube and the second single rod or tube are optically isolated from each other.

43. The dental light guide of claim 42 wherein the means for transmitting light received from one or more light sources comprise a single tube and wherein the means for receiving light reflected from the dental restoration comprise a single rod and wherein the single tube surrounds the single rod.

44. The dental light guide of claim 38 wherein the means for transmitting light and means for receiving light consisting of a single continuous homogeneous material.

45. The dental light guide of claim 44 wherein the single homogeneous material is selected from the group consisting of glass rod, a glass clad rod, a plastic rod, a plastic rod with optical coating, and a light transmitting tube.

46. The dental light guide of claim 38 wherein the means for transmitting light and means for receiving light are constructed of materials selected from the group consisting of fibers, glass rod, plastic rod, and light transmitting tube containing a total internal reflection (TIR) element.

47. The dental light guide of claim 38 wherein the means for transmitting light comprises a total internal reflector element that captures and transmits light emitted from the light source towards the dental restoration.

48. The dental light guide of claim 38 wherein the means for receiving light reflected from the dental restoration comprises a total internal reflector element that captures and transmits reflected light from the target towards the one or more light sensing devices.

49. The dental light guide of claim 38 further comprising a protective covering for infection control.

50. The dental light guide of claim 49 wherein the protective covering is disposable.

51. The dental light guide of claim 50 wherein the protective covering is reusable.
